(19) United States
(12) Patent Application Publication
(10) Pub. No.: US 2020/0217269 A1
(43) Pub. Date: Jul. 9, 2020

(54) PISTON HAVING AN UNDERCROWN SURFACE WITH INSULATING COATING AND METHOD OF MANUFACTURE THEREOF

(71) Applicant: Tenneco Inc., Lake Forest, IL (US)

(72) Inventors: Timothy C. Vezina, Northville, MI (US); Warran Boyd Lineton, Chelsea, MI (US); Jeffrey Lee Riffe, Troy, MI (US); Michael Weinenger, Southfield, MI (US)

(21) Appl. No.: 16/240,568

(22) Filed: Jan. 4, 2019

(51) Int. Cl. F02F 3/10; F02F 3/16; C09D 163/00; B32B 7/08

(52) U.S. Cl. CPC F02F 3/10; F02F 3/16; F02F 2003/0007; B32B 7/08; F02F 2200/00; C09D 163/00

(57) ABSTRACT

A vehicle internal combustion piston and method of construction thereof are provided. The piston includes piston body extending along a central longitudinal axis, having an upper combustion wall forming an upper combustion surface and an undercrown surface opposite the upper combustion surface. An annular ring belt region depends from the upper combustion surface, a pair of skirt panels depend from the ring belt region, and a pair of pin bosses depend from the undercrown surface to provide laterally spaced pin bores aligned along a pin bore axis for receipt of a wrist pin. The undercrown surface forms a central undercrown region, and a portion of either an open outer cooling gallery, a sealed outer cooling gallery, or an outer galleryless region, wherein an insulating coating including a thermoset resin, such as a phenolic or epoxy resin, with additives is applied to at least one of the portions of the undercrown surface.

### BACKGROUND OF THE INVENTION

### 1. Field of the Invention

This invention relates generally to pistons for internal combustion engines, and methods for manufacturing the pistons.

### 2. Related Art

Pistons used in internal combustion engines, such as heavy duty diesel pistons, are exposed to extremely high temperatures during operation, especially along the crown of the piston. Engine and piston manufacturers typically attempt to control the temperature of the crown and reduce heat loss from the combustion chamber to the crown, in order to maintain usable fuel energy and high gas temperature inside the combustion chamber, and to achieve a higher engine brake thermal efficiency (BTE).

To moderate the temperature of the crown, some pistons are designed with a cooling gallery beneath the crown, wherein cooling oil is sprayed into the cooling gallery and onto an undercrown surface as the piston reciprocates along a cylinder bore of the engine. The oil flows along the inner surface of the cooling gallery and dissipates heat from the crown. However, to control the piston temperature during operation, a high flow of oil must be constantly maintained, which adds to the parasitic losses, which in turn reduces the engine fuel efficiency. In addition, the oil degrades over time due to the high temperature of the internal combustion engine, and thus, the oil must be changed periodically to maintain adequate engine life. Furthermore, when the piston cooling gallery and/or undercrown temperature is exposed to high temperatures over a prolonged period of time, the oil tends to coke at an increased rate, and resulting deposits of coked oil may buildup on the inner surface of the cooling gallery and/or on the undercrown.

Another way to control the temperature of the crown is to design the piston with a sealed cooling gallery containing coolant media which are more heat resistant than oil when exposed to high temperatures. U.S. Pat. No. 9,127,619 discloses an example of a piston including a sealed cooling gallery partially filled with a liquid containing metal particles having a high thermal conductivity. The liquid carries the metal particles throughout the cooling gallery as the piston reciprocates in the internal combustion engine, and the metal particles remove heat from the crown. The metal particles can re-distribute the heat flow, and thus also reduces cooling gallery deposits, and oil degradation.

However, engine and piston manufacturers continuously strive to develop new and improved ways to reduce the temperatures of undercrown and/or cooling gallery surfaces, reduce the build-up of coked oil deposits and carbon on cooling gallery and/or undercrown surfaces, reduce engine oil degradation, and lengthen the time between necessary engine oil change intervals.

In particular, it is desired to cost effectively reduce cooling oil degradation rates when using lightweight steel pistons having a galleryless design in power dense applications without adding too much weight. The same goal is desired wen using lightweight gallery containing designs in extremely high power density applications without adding too much weight.

### SUMMARY

One aspect of the invention provides a piston for an internal combustion engine that is able to exhibit a reduced surface temperature during operation, which provides for less surface deposits and a reduced tendency for degradation of cooling oil. The piston includes a piston body extending along a central longitudinal axis. The piston body includes an upper combustion wall forming an upper combustion surface and an undercrown surface opposite the upper combustion surface. The piston body also includes a ring belt region depending from the upper combustion surface, a pair of skirt panels depending from the ring belt region, and a pair of pin bosses depending from the undercrown surface, the pin bosses providing a pair of laterally spaced pin bores. The piston body further includes one of an open outer cooling gallery forming a portion of the undercrown surface, a sealed outer cooling gallery forming a portion of the undercrown surface, and an outer galleryless region forming a portion of the undercrown surface. The piston body also includes a central undercrown region forming a portion of the undercrown surface. An insulating coating is applied to at least one of the portions of the undercrown surface, and the insulating coating includes a thermoset resin and at least one of barium sulfate, carbon fibers, ceramic fibers, coke, graphite, mica, wollastonite, mullite, metal oxides, and zirconia.

Another aspect of the invention provides a method of manufacturing the piston for an internal combustion engine. The method comprises the steps of providing the piston body, and applying the insulating coating to at least one of the portions of the undercrown surface.

### BRIEF DESCRIPTION OF THE DRAWINGS

These and other aspects, features and advantages of the invention will become more readily appreciated when considered in connection with the following detailed description, appended claims and accompanying drawings, in which:

FIG. 1 is a dual cross-sectional side view of a piston constructed in accordance with one aspect of the invention shown taken generally transversely to a pin bore axis to the left of axis A, and shown taken generally along the pin bore axis to the right of axis A;

FIG. 1A is a view similar to FIG. 1 of a piston constructed in accordance with another aspect of the invention;

FIG. 1B is a dual cross-sectional side view of a piston constructed in accordance with another aspect of the invention shown taken generally transversely to a pin bore axis to the left of axis A, and shown taken generally along the pin bore axis to the right of axis A;

FIG. 2 is a view similar to FIG. 1 of a piston constructed in accordance with another aspect of the invention; and

FIG. 3 is a view similar to FIG. 1 of a piston constructed in accordance with yet another aspect of the invention.

### DETAILED DESCRIPTION OF EXEMPLARY EMBODIMENTS

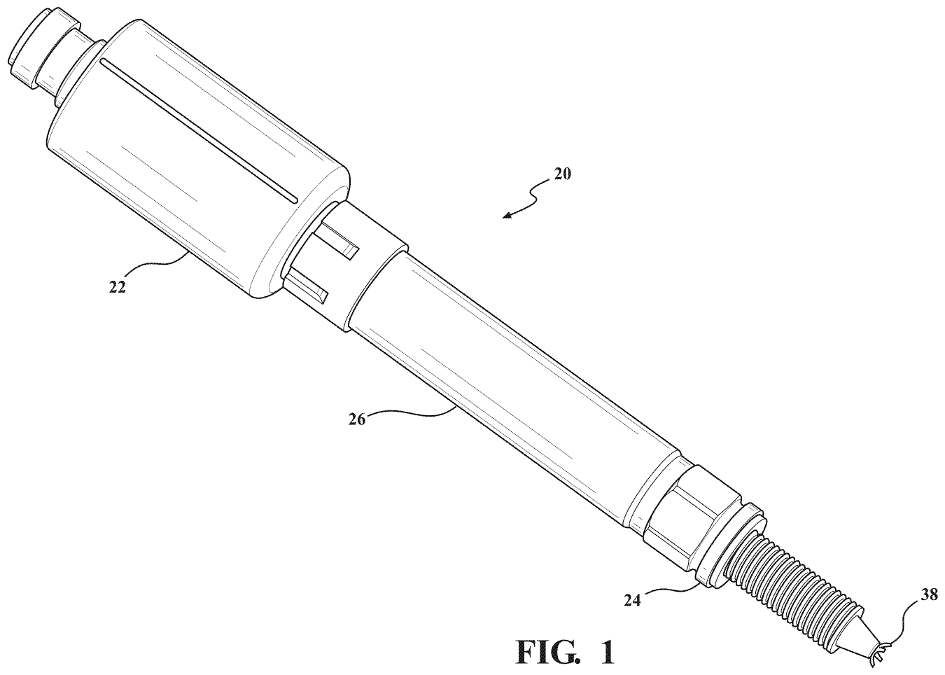

Referring in more detail the drawings, FIGS. 1, 1A-3 illustrate respective pistons 20, 20′, 20″, 20′″ for an internal combustion engine according to different example embodiments of the invention. The pistons 20, 20′, 20″, 20′″ are discussed hereafter using the same reference numerals to identify like features. The pistons 20, 20′, 20″, 20′″ each have a body 22 formed of a metal material, such as steel, cast iron, or a non ferrous material, such as aluminum. The body 22 extends along a center axis A, along which the pistons 20, 20′, 20″, 20′″ reciprocate in use, from an upper end 24 to a lower end 26. The body 22 of the pistons 20, 20′, 20″, 20′″ include a crown 28 at the upper end 24 of an upper combustion wall 29, wherein the crown 28 is directly exposed to a combustion chamber and hot gases therein during use, with a combustion bowl 30 depending therein.

In the example embodiments, the combustion bowl 30 of the body 22 presents an apex region 31 about the center axis A, a concave, toroidal bowl-shaped valley region 33 surrounding the center axis A, and a bowl-rim 35 surrounding the valley 33. An annular ring belt 32 depends from the crown 28 to present a plurality of ring grooves 37 facing away from the center axis A and extending circumferentially around the center axis A.

The pistons 20, 20′, 20″, 20′″ further include a lower part presenting a pair of pin bosses 34, each depending from the crown 28, having pin bores 36 aligned with one another along a pin bore axis 38 extending perpendicular to the center axis A for receiving a wrist pin (not shown). The body 22 also includes a pair of diametrically opposite skirt panels 40 depending from the crown 28 and extending along a circumferential direction partially about the center axis A along opposite sides of the pin bore axis 38. The skirt panels 40 are joined to the pin bosses 34 via strut portions 42. It is noted that the body 22 of the pistons 20, 20′, 20″, 20′″ could comprise various other designs and features than those shown in FIGS. 1, 1A-3.

The lower part of the body 22 of the piston 20 also presents an undercrown surface 44 on an opposite side of the upper combustion wall 29 from the crown 28, and facing opposite the combustion bowl 30. The piston 20 can optionally include an outer cooling gallery 46 in addition to the undercrown surface 44, as shown in FIGS. 1 and 1A. In these embodiments, the outer cooling gallery 46 is disposed adjacent the ring belt 32 in radial alignment or substantial radial alignment therewith (substantial is intended to mean that at least a portion of the outer cooling gallery 46 is radially aligned with the ring belt 32, but a portion may not be radially aligned with the ring belt 32), wherein the cooling gallery 46 extends circumferentially around the center axis A. As shown in FIG. 1, the outer cooling gallery 46 can be sealed to contain a cooling media therein, which can be a solid, liquid, and/or gas. According to one embodiment, the sealed outer cooling gallery 46 can be filled with air. Otherwise, as shown in FIG. 1A, the outer cooling gallery 46 can be open, thereby including inlet and outlet openings 48, 49, such that cooling oil from a crankcase can enter and exit the outer cooling gallery 46, such as by being sprayed into the inlet opening 48 and allowed to exit the outlet opening 49. If desired, the inlet and outlet openings 48, 49 can be sealed, for example a plug, adhesive, weld, or braze, with the desired cooling medium disposed therein, to form the sealed cooling gallery of FIG. 1.

In the examples of FIGS. 1 and 1A, the piston 20, 20′ includes a central region of the undercrown surface 44 located along the center axis A and surrounded by the sealed or open outer cooling gallery 46. The central region of the undercrown surface 44 is open and shown located directly opposite the apex region 31 of the combustion bowl 30 so that cooling oil from the crankcase can be sprayed or splashed onto the central region of the undercrown surface 44. However, the central region of the undercrown surface 44 could alternatively be closed or sealed off from direct exposure to the crankshaft region. A further portion of the undercrown surface 44 is formed by the uppermost surfaces of the open or sealed outer cooling gallery 46 opposite the valley region 33. It is noted that the center region of the undercrown surface 44 does not need to be open as shown in FIGS. 1 and 1A. The body 22 could also include an inner wall 52 providing another section of the central region of the undercrown surface 44, as shown in FIG. 1B. In the example embodiment, this inner wall 52 includes a drilled opening.

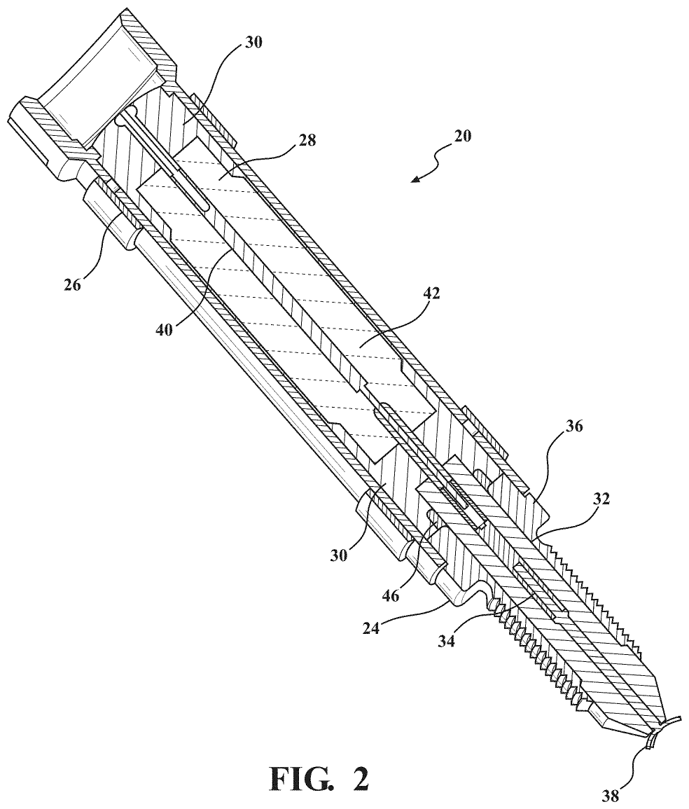

In the example embodiment of FIG. 2, the piston 20″ does not include a closed or sealed outer cooling gallery, but instead includes an open outer galleryless region 46′ and the central region of the undercrown surface 44, which are both openly exposed along the lower part of the piston 20″. The open galleryless region 46′ is shown as extending only along a pair of diametrically opposite regions of the piston 20″, wherein one of the regions extends along one side of the pin bore axis 38 generally parallel thereto and generally transversely to a thrust axis axis 38′, and the other of the other of the regions extends along another side of the pin bore axis 38 generally parallel thereto and generally transversely to the thrust axis 38′. Accordingly, the open galleryless region 46′ is formed to extend along opposite sides of the pin bore axis 38, radially inwardly from the skirt panels 40 and in radial alignment with or substantial radial alignment with the ring belt 32. In the embodiment of FIG. 2, a further outer portion of the undercrown surface 44 is formed by the uppermost surfaces of the outer galleryless region 46′, and portions of the pin bosses 34 located above the pin bores 36 and extending to the ring belt 32 are solid piston body material. The central region of the undercrown surface 44 and the outer portion of the undercrown surface 44 extends from the center axis A to the regions of the ring belt 32 located in axial alignment with the skirt panels 40.

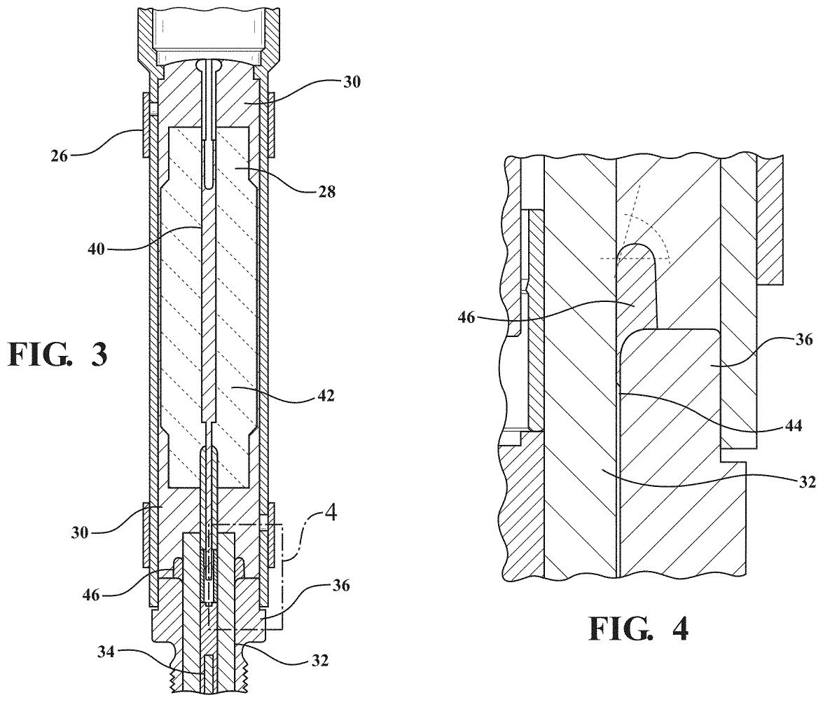

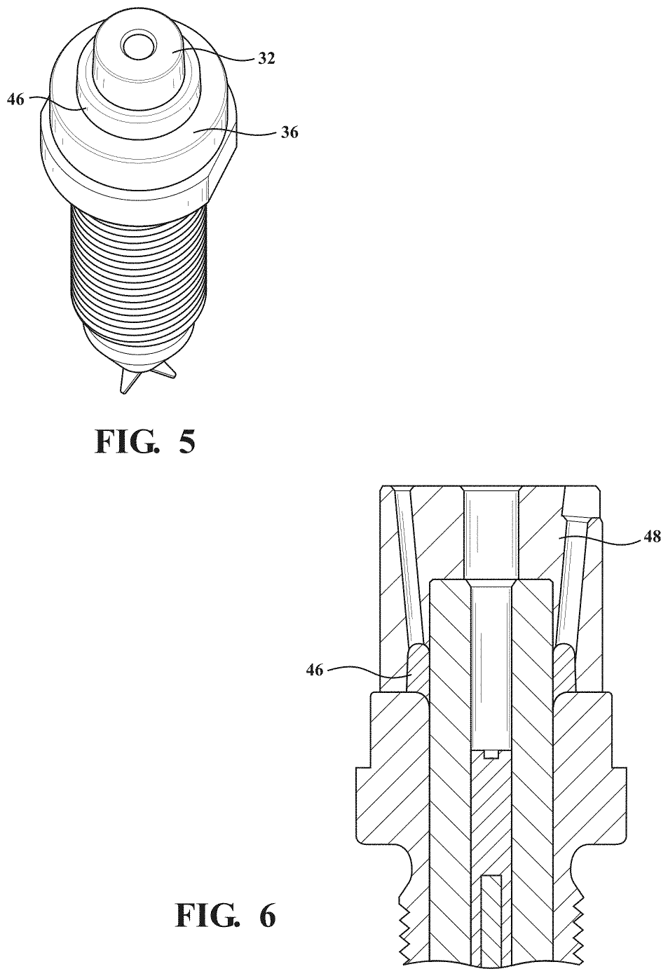

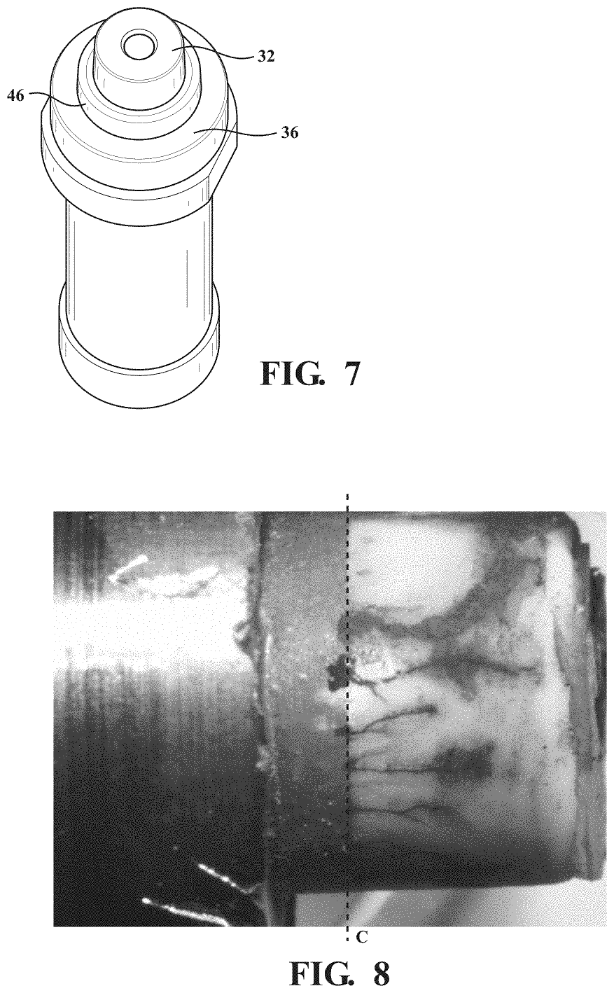

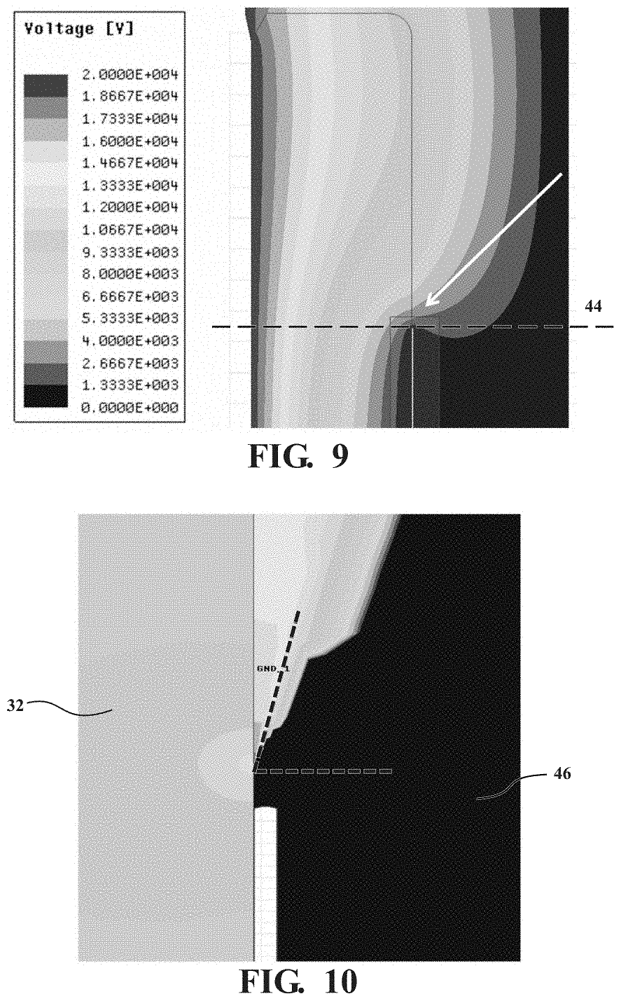

In the embodiment of FIG. 3, the piston 20′″ is similar to the piston 20″; however, rather than having an entirely solid piston body portion above and axially aligned with the pin bosses 34, extending to the ring belt 32, a pocket or second open outer galleryless region 46″ is located radially outwardly of the pin bosses 34 adjacent and in radial alignment with the ring belt 32. As such, the second open outer galleryless region 46″ allows the cooling of the entirety or substantial entirety of the ring belt region 32 to be enhanced via the combined circumferentially continuous configuration provided by the first and second galleryless regions 46′, 46″. In the embodiment of FIG. 3, the undercrown surface 44 is provided by the combination of the uppermost surfaces/portions of the open galleryless regions 46′, 46″ generally opposite the valley region 33 of the combustion bowl 30 and the central region of the undercrown surface 44 opposite the apex region 31 of the combustion bowl 30.

An insulating coating 50 is applied to at least a portion of the undercrown surface 44, and thus, to at least one of the undercrown portions provided by the open or sealed outer cooling gallery 46, and/or the outer galleryless regions 46′, 46″, and/or the open or sealed central region of the undercrown surface 44, to reduce the temperature of the surfaces being covered thereby, and thus, reduce carbon deposits and oil coking. At least one layer of the insulating coating 50 is applied, but multiple layers can be applied to reduce surface roughness, fill in porosity, and create anti-stick properties to reduce carbon deposits and oil coking. The insulating coating 50 has a thermal conductivity which is lower than a thermal conductivity of the metal material used to form the piston body 22.

The insulating coating 50 includes a thermoset resin, such as phenolic or epoxy resin, including straight or modified resins. The insulating coating 50 also includes additives, such as at least one of barium sulfate, carbon fibers, ceramic fibers, coke, graphite, mica, wollastonite, mullite, metal oxides, and zirconia. The insulating coating 50 typically has a thermal conductivity ranging from 0.5 to 10 W/m·K; a thickness of 0.1 to 5 mm; and a porosity of 1 to 30%. The density of the coating 50 is typically 0.9 to 3.5 g/cm³, for example when the coating 50 is a friction material formulation. If the coating 50 is applied by thermal spraying, such as plasma, wire arc, or high velocity oxygen fuel (HVOF), then the coating 50 typically has a density of 6.0 to 7.0 g/cm³.

In an example embodiment, the insulating coating 50 includes the phenolic resin, or another thermoset resin, in an amount of 4 to 100 weight percent (wt. %), based on the total weight of the insulating coating 50. Alternatively, the insulating coating 50 could include the epoxy resin or another thermoset resin in an amount of 4 to 100 wt. %. In this embodiment, the insulating coating 50 also includes the additives, specifically at least one of barium sulfate, carbon fibers, ceramic fibers, coke, graphite, mica, wollastonite, mullite, metal oxides, and zirconia, in an amount of 0 to 96 wt. %, based on the total weight of the insulating coating 50.

The insulating coating 50 could be applied to the entire undercrown surface 44. However, the insulating coating 50 may be applied to less than the entire undercrown surface 44 of the piston body 22. For example, the insulating coating 50 can be selectively applied to regions of the undercrown surface 44 that are able to most significantly reduce temperatures of the undercrown surface 44. For example, the insulating coating 50 can be applied to only the central region of the undercrown surface 44, only the open or sealed outer cooling gallery 46, and/or only one of the outer galleryless regions 46′, 46″ forming a portion of the undercrown surface 44. Alternatively, the insulating coating 50 can be applied to two or more, but less than all of, those regions.

In addition, the insulating coating 50 can be applied to less than all of one or more of the following portions: the open or sealed outer cooling gallery 46, the outer galleryless regions 46′, 46″, and the central region of the undercrown surface 44. The insulating coating 50 can be applied as a patch, as shown in FIG. 2. For example, the insulating coating 50 can be applied to a first area of one of the portions of the undercrown surface 44 but not a second area of the same one of the portions of the undercrown surface 44.

In one example embodiment, as shown in FIGS. 2 and 3, the piston body 22 includes the outer galleryless region 46′, 46″ forming a portion of the undercrown surface 44, and the insulating coating 50 is applied to the portion of the undercrown surface 44 formed by the outer galleryless region 46′, 46″. In this case, the insulating coating 50 can be applied to less than all of the portion of the undercrown surface 44 formed by the outer galleryless region 46′, 46″.

According to another example embodiment, as shown in FIG. 1A, the piston body 22 includes the open outer cooling gallery 64 forming a portion of the undercrown surface 44, the oil inlet opening 48 configured for oil to be sprayed in the open cooling gallery 46, and the outlet opening 49 configured for the oil to exit the open outer cooling gallery 46. In this case, the insulating coating 50 is applied to the portion of the undercrown surface 44 formed by the open outer cooling gallery 64.

According to yet another example embodiment, as shown in FIG. 1A, the piston body 22 includes the sealed outer cooling gallery 64 forming a portion of the undercrown surface 44. In this case, the insulating coating 50 is applied to the portion of the undercrown surface 44 formed by the closed outer cooling gallery 64.

In the embodiments of FIGS. 1, 1A, 2, and 3, the insulating coating 50 is also applied to the central region of the undercrown surface 44.

The insulating coating 50 can reduce the temperature of the undercrown surface 44 and thus the temperature of the lower part of the body 22 of the piston 20, 20′, 20″, 20′″. The insulating coating 50 can also minimize deposits, minimize oil degradation in the engine, and/or reduce heat flow through the piston 20, 20′, 20″, 20′″.

Another aspect of the invention provides a method of manufacturing the piston 20, 20′, 20″, 20′″ including the insulating coating 50. The body 22 of the piston 20, 20′, 20″, 20′″, which is typically formed of steel, cast iron, or a ferrous material containing aluminum, can be manufactured according to various different methods, such as forging or casting. The body 22 of the piston 20, 20′, 20″, 20′″ can also comprise various different designs, and examples of the designs are shown in FIGS. 1, 1A-3.

The method further includes applying the insulating coating 50 to at least a portion of the undercrown surface 44, including at least a portion of the central region of the undercrown surface 44, and/or at least a portion of the outer cooling gallery 46, and/or at least a portion of the first and/or second open outer galleryless region 46′, 46″. Various different methods can be used to apply the insulating coating 50. For example, the insulating coating 50 can be spray coated, plated, cast, or in any way permanently attached the metal body 22 of the piston 20, 20′, 20″, 20′″. Coatings containing thermoset resins, such as phenolic or epoxy resins, require curing, typically between 120 and 280° C. for 1 to 60 minutes. Complete cure is not always required since additional cure can be generated when the piston is in service and the under-crown regions reach temperatures in excess of 200° C.

In one embodiment, the insulating coating 50 is applied by thermal spraying. For example, the method can include applying metal bond material and the ceramic material by a thermal spray technique, such as plasma spraying. High velocity Oxy-Fuel (HVOF) spraying is an another alternative process that can be used to apply the insulating coating 50. Wire-arc spraying is yet another alternative process that can be used to apply the insulating coating 50. Other methods of applying the insulating coating 50 to the piston body 22 can also be used.

The insulating coating 50 can be applied to the entire undercrown surface 44, but the insulating coating 50 is typically selectively applied to certain areas of the undercrown surface 44 and less than the entire undercrown surface 44. For example, the insulating coating 50 can be selectively applied to regions of the undercrown surface 44 that are able to most significantly reduce temperatures of the undercrown surface 44. For example, the insulating coating 50 can be applied to only the central region of the undercrown surface 44, only the outer cooling gallery 46, or only one of the outer galleryless regions 46′, 46″ forming a portion of the undercrown surface 44. Alternatively, the insulating coating 50 can be applied to two or more, but less than all of, those regions. The insulating coating 50 can also be applied to only a small area of one of the portions of the undercrown surface 44.

In order to selectively apply the insulating coating 50, the method typically includes masking at least one area of at least one of the portions of the undercrown surface 44 while applying the insulating coating 50. The step of applying the insulating coating 50 also typically includes applying the insulating coating 50 to less than all of the portions of the undercrown surface 44. The method can include applying the insulating coating 50 in as a patch or in patches, as shown in FIG. 2. For example, the insulating coating 50 can be applied to a first area of one of the portions but not a second area of one of the portions of the undercrown surface 44. Alternatively, the step of applying the insulating coating 50 can include precision spraying with an appropriate spray head or nozzle, dipping, rolling, hot transferring, or painting.

The method of manufacturing the piston 20 further includes curing the insulating coating 50 at a temperature ranging from 120 to 280° C. and for a time of 1 to 60 minutes. The thermal conductivity of the patches of the insulating coating 50 can be adjusted by changing the coating cure conditions and phenolic chemistry or other thermoset resin chemistry. For example, straight or modified resins or mixes may be used with the knowledge that the specific resin chemistry liberates different quantities of cure gases (ammonia and water). The cure operation generates gas according to the heating rate. Fast, hot cure tends to form highly porous structures (e.g. >200° C. for 10 minutes). Slower cure gives less gas and hence less porosity (120° C. for several hours). As with brake pad formulations, the fillers and additives are added to reinforce the structure and change thermal properties. Examples of the additives and fillers are barium sulfate, carbon fibers, ceramic fibers, coke, graphite, mica, wollastonite, mullite, metal oxides, zirconia, and others. Preferably, the insulating coating 50 is not applied to the upper combustion surface, ring belt 32, or pin bores 36 of the piston body 22.

The piston 20 and method described herein provides several advantages, especially with regard to the galleryless designs. Testing of current galleryless pistons has shown a maximum undercrown coking accumulation of 2 mm. As coking thickness increases, oil degradation rates plummet. It is believed that the low heat transfer coefficient (HTC) of undercrown coking deposits insulates the oil from the negative impact of the hot piston 20. The insulating coating 50 described herein mimics the insulative properties of undercrown coking. The coating density can be manipulated to optimize the thermal conductivity and heat transfer coefficient (HTC), but the coating thickness will be significant, approaching 2 mm, and the coating thickness will only be restrained by geometry and adhesion constraints. As described above, the insulating coating 50 can be selectively applied to the portions of the undercrown surface 44 that will most significantly reduce the undercrown temperatures to control heat flow through the piston 20 such that oil degradation is minimized. The coating 55 is an improvement to other polymer-based insulating coatings, as thermal conductivity can be adjusted by controlling the cure rate and chemistry of the phenolic or other thermoset resin, hence changing the void content of the cured coating. The additives also play a role in adjusting the mechanical and thermal properties.

Many modifications and variations of the present invention are possible in light of the above teachings and may be practiced otherwise than as specifically described while remaining within the scope of the claims. It is contemplated that all features of all claims and of all embodiments can be combined with each other, so long as such combinations would not contradict one another.

What is claimed is:

1. A piston for an internal combustion engine, comprising:
a piston body extending along a central longitudinal axis;
said piston body having an upper combustion wall forming an upper combustion surface and an undercrown surface opposite said upper combustion surface;
said piston body including a ring belt region depending from said upper combustion surface, a pair of skirt panels depending from said ring belt region, and a pair of pin bosses depending from said undercrown surface, said pin bosses providing a pair of laterally spaced pin bores;
said piston body including one of an open outer cooling gallery forming a portion of said undercrown surface, a sealed outer cooling gallery forming a portion of said undercrown surface, and an outer galleryless region forming a portion of said undercrown surface;
said piston body including a central undercrown region forming a portion of said undercrown surface; and
an insulating coating applied to at least one of said portions of said undercrown surface, and said insulating coating including a thermoset resin and at least one of barium sulfate, carbon fibers, ceramic fibers, coke, graphite, mica, wollastonite, mullite, metal oxides, and zirconia.

2. The piston of claim 1, wherein said thermoset resin is a phenolic resin or an epoxy resin.

3. The piston of claim 1, wherein said insulating coating has a thermal conductivity ranging from 0.5 to 10 W/m·K.

4. The piston of claim 1, wherein said insulating coating has a thickness of 0.1 to 5 mm, a density of 0.9 to 3.5 g/cm³ or 6.0 to 7.0 g/cm³, and a porosity of 1 to 30%.

5. The piston of claim 1, wherein said piston body is formed of steel, cast iron, or aluminum.

6. The piston of claim 1, wherein said insulating coating includes the thermoset resin in an amount of 4 to 100 weight percent (wt. %) and said at least one of barium sulfate, carbon fibers, ceramic fibers, coke, graphite, mica, wollastonite, mullite, metal oxides, and zirconia in an amount of 0 to 96 wt. %, based on the total weight of said insulating coating.

7. The piston of claim 1, wherein insulating coating is applied to less than all of said portions of said undercrown surface.

8. The piston of claim 1, wherein said insulating coating is applied to a first area of one of said portions of said undercrown surface but not a second area of the same one of said portions of said undercrown surface.

9. The piston of claim 1, wherein said piston body includes an outer galleryless region forming a portion of said undercrown surface, and said insulating coating is applied to said portion of said undercrown surface formed by said outer galleryless region.

10. The piston of claim 9, wherein said insulating coating is applied to less than all of said portion of said undercrown surface formed by said outer galleryless region.

11. The piston of claim 1, wherein said piston body has said open outer cooling gallery forming a portion of said undercrown surface, an inlet configured for oil to be sprayed in said open cooling gallery, and an outlet configured for the oil to exit said open cooling gallery; and said insulating coating is applied to said portion of said undercrown surface formed by said open outer cooling gallery.

12. The piston of claim 1, wherein said piston body includes a sealed outer cooling gallery forming a portion of said undercrown surface, and said insulating coating is applied to said portion of said undercrown surface formed by said sealed outer cooling gallery.

13. The piston of claim 1, wherein said piston body includes a central undercrown region forming a portion of said undercrown surface, and said insulating coating is applied to said portion of said undercrown surface formed by said central undercrown region.

14. A method of manufacturing a piston for an internal combustion engine, comprising the steps of:
providing a piston body extending along a central longitudinal axis;
the piston body having an upper combustion wall forming an upper combustion surface and an undercrown surface opposite the upper combustion surface, a ring belt region depending from the upper combustion surface, a pair of skirt panels depending from the ring belt region, and a pair of pin bosses depending from the undercrown surface, the pin bosses providing a pair of laterally spaced pin bores;
the piston body including one of an open outer cooling gallery forming a portion of the undercrown surface, a sealed outer cooling gallery forming a portion of the undercrown surface, or an outer galleryless region forming a portion of said undercrown surface, and the piston body include a central undercrown region forming a portion of said undercrown surface; and
applying an insulating coating to at least one of the portions of the undercrown surface, the insulating coating including a thermoset resin and at least one of barium sulfate, carbon fibers, ceramic fibers, coke, graphite, mica, wollastonite, mullite, metal oxides, and zirconia.

15. The method according to claim 14 including masking at least one area of at least one of the portions of the undercrown surface while applying the insulating coating.

16. The method according to claim 14, wherein the step of applying the insulating coating includes applying the insulating coating to less than all of the portions of the undercrown surface.

17. The method according to claim 14, wherein the step of applying the insulating coating includes applying the insulating coating to a first area of one of the portions but not a second area of one of the portions of the undercrown surface.

18. The method of claim 14, wherein the step of applying the coating includes precision spraying.

19. The method of claim 14, wherein the step of applying the coating includes dipping, rolling, hot transferring, or painting.

20. The method of claim 14 including curing the insulating coating at a temperature ranging from 120 to 280° C. and for a time of 1 to 60 minutes.
